(19) United States
(12) Patent Application Publication
(10) Pub. No.: US 2002/0069097 A1
(43) Pub. Date: Jun. 6, 2002

(54) Database management system and method

(76) Inventor: Lawrence R. Conrath, Lockport, IL (US)

Correspondence Address: MCDONNELL BOEHNEN HULBERT & BERGHOFF, 300 SOUTH WACKER DRIVE, SUITE 3200, CHICAGO, IL, 60606, US

(21) Appl. No.: 09/920,361

(22) Filed: Aug. 1, 2001

Related U.S. Application Data
(60) Provisional application No. 60/222,241, filed on Aug. 1, 2000.

(51) Int. Cl. G06F 17/60

(52) U.S. Cl. 705/7

(57) ABSTRACT

A system and method for collecting and distributing designed to address the update timeliness of data changes. The system and method uses the “Organizational Directory Management Services” (ODMS) approach to maximize a needed business management tool with current technology capability. In one aspect, ODMS is used to efficiently collect and analyze data for scheduled events, such as collecting data regarding a waste route. In another aspect, ODMS is used to collect and organize data regarding the planning of a wedding.

### REFERENCE TO RELATED APPLICATIONS

The current patent application claims priority to U.S. patent application Ser. No. 60/222,241 filed on Aug. 1, 2000 and entitled “Organization Directory Management Services.” This application incorporates by reference U.S. patent application Ser. No. 60/222,241 in its entirety.

### FIELD OF THE INVENTION

The invention relates generally to data management and publishing services to be marketed and provided to a variety of organizations as an out-sourced value added business productivity enhancement. More specifically, the invention is a process and apparatus to provide data capture, data organization, and data distribution services of organization directories, to contracted clients, at a quality controlled and secured centralized data center.

### BACKGROUND OF THE INVENTION

Data management, and in particular database management, has been a continuing problem in industry. With the explosion of available data from various sources, such as the internet, marketing data, etc., there is a great opportunity for a company to capitalize on that data. However, along with the explosion of data are the attendant problems associated with management of the data.

Moreover, there are four market-force driven phenomena occurring in the business arena lately that have created opportunities and also attendant problems for industry:

1. The pace of technological advancement in computerized hardware and software systems have given businesses the ability to assemble significantly larger pools of data electronically than has ever been available before.

2. Organizations continue to rapidly grow in sheer size as a result of an accelerated occurrence of consolidations and merger activity. This growth results in fast-paced, continuing changes to the organization's facility and personnel rosters.

3. The use of new communication services and products has increased dramatically with a typical organization now having potentially five telephone access numbers and three addresses that may need to be chronicled for employees/associates:

| | |
|---|---|
| 1. Voice line | 1. Office Address |
| 2. Facsimile line | 2. Email Address |
| 3. Mobile line | 3. Home Address |
| 4. Pager line | |
| 5. Home voice line | |

4. As a result of a sustained period of economic growth, in conjunction with population changes, the labor pool available to fill clerical positions has diminished with respect to both qualified and quantities of individuals, which has created a tight labor market and recruitment problem for large and growing organizations. In-house resources dedicated to pure data entry responsibility continues to consume more management time and focus. As an alternative, the ability to out source data entry services becomes a cost effective solution for organizations experiencing rapid growth and change in a tight labor market.

One problem is that organizations need a cost-effective method of assembling, tracking, and continuously updating data of their facilities and people in a directory fashion. Existing methods involve a variety of data gathering techniques utilizing people and systems internally. Word-processed or handwritten lists become outdated as soon as they are compiled due to the real-time changes that occur in all organizations. There is typically little attention given to the system of data compilation used, the technologies employed, or standards implemented in assembling an organization's management directory. Distribution to personnel needing the information is often not consistent throughout the organization's various facilities. This can often result in untimely or inaccurate data embedded in the directories, and missed distributions to key users. Recognizing that in house resources are being taxed due to the market forces described above, a necessary alternative of an outsourced reliable resource needs to be developed.

### SUMMARY OF THE INVENTION

The present invention overcomes the drawbacks of the current methods used to capture data into organization directories. Though a systematic controlled approach in collecting and distributing the data through a proven technology that is designed specifically to address the update timeliness of data changes, the “Organizational Directory Management Services” (ODMS) approach is a process designed to maximize a needed business management tool with current technology capability.

Specifically, due to the accelerated pace at which an organization's directory information changes, delegated management of this data to a reliable third party services provider using the most recent technology available becomes an alternative strategy which maintains timely, value added, accurate organization directories. The invention provides a solution that would allow organizational management to free up internal resources to focus more on the organization's strategic business goals and initiatives. The organization gains a defined directory management resource to keep its directory management data current and accurate, and can be distributed to the key departments in the organization at prearranged regular intervals. This benefit can be communicated to the organization's employees/associates as a necessary business productivity enhancement, utilizing state of the art technology, and provide a positive, pro-active, senior management image to its users throughout the organization.

In one embodiment of the invention, the ODMS is applied to collect and organize data for a route with scheduled stops. One example of this embodiment of the invention is the collection, organization and analysis of data for a waste industry route. An electronic route book contains sequenced customer data regarding stops for a waste route. Route stop data and/or cost/productivity data may be gathered. The data may then be analyzed based on various criteria. In one manner, the data may be analyzed to determine cost efficiency. Alternatively, the data may be analyzed to determine time efficiency. This analysis may then be used to effect operational and marketing changes for waste industry routes.

In an alternate embodiment of the invention, the ODMS is applied to collect and organize data for event planning. One example of this embodiment of the invention is the collection and organization of a wedding. In one aspect, guest lists may be generated to manage more effectively the invited guest selection process. For example, a master invited guest list may be assembled from lists generated by the bride, groom, the bride's family and the groom's family. This master list may, in turn, be modified into an attending list based on results from replies to invitations. In another aspect, the list of guests may be used for various aspects of the wedding preparation including: (1) addressing and special instructions for invitees; (2) generating printed lists to assist in various functions for wedding service providers (such as photographers, videographers, etc.); (3) generating place cards for the reception; and (4) assisting in generating thank-you cards including addressing and personalizing the thank-you cards.

### BRIEF DESCRIPTION OF THE DRAWINGS

FIG. 1 shows a block diagram of the hardware in one embodiment of the system.

FIG. 2 is a block diagram illustrating a PID according to an exemplary embodiment of the present invention.

FIG. 3 shows a process flow diagram for establishing the ODMS platform and service center.

FIG. 4 shows a process flow diagram for the ODMS client interview.

FIG. 5 shows a process flow diagram for the ODMS data collection.

FIG. 6 shows a process flow diagram for the ODMS data distribution.

FIG. 7 shows a process flow diagram of a waste route database management system.

FIG. 8 shows a process flow chart of a wedding planning database management system.

### DETAILED DESCRIPTION OF THE INVENTION

The presently preferred embodiments of the invention will now be described by reference to the accompanying figures, wherein like elements are referred to by like numerals.

As discussed in the background of the invention, database management is a continuing problem in industry. With the explosion of available data from various sources, such as the internet, marketing data, etc., there is a great opportunity for a company to capitalize on that data. However, along with the explosion of data are the attendant problems associated with management of the data.

Definitions:

| | |
|---|---|
| “ODMS” | Acronym for Organization Directory Management |
| | Services which references the business management |
| | facility and computer systems that collects, maintains, |
| | and distributes the proprietary services. |
| “OS” | The Operating System which currently runs many hand |
| | held device systems, such as those owned by Palm, |
| | Inc. and licensed for many alternate uses. One feature |
| | of the OS involves an asynchronous data exchange |
| | between hand helds and host desktop computer |
| | systems and/or centralized secure electronic databases/ |
| | servers. |
| “ODMS_SCPU” | Acronym for “Organization Directory Management |
| | Services secured computer processing unit” which is |
| | the main secured electronic database unit from which |
| | the organizational directories are created, maintained, |
| | and enact electronic and other distribution capabilities. |
| “ODMS_PS” | Acronym for the “Organization Directory Management |
| | Services print shop products” which references |
| | marketable hard copy products that are a byproduct of |
| | the SCPU distribution capabilities. |
| “ODMS_CKM” | Acronym for the “Organization Directory Management |
| | Services client key manager” who is designated by the |
| | customer as the decision maker for the customer needs. |
| “ODMS_CSR” | Acronym for the “Organization Directory Management |
| | services customer service representative” who is |
| | designated by ODMS management to oversee the |
| | customer needs and coordinates the customer |
| | communications and timetable for product deliveries. |
| “ODMS_CDRC” | Acronym for “Organization Directory Management |
| | Services client designated receiver computers” which |
| | is the customer defined hardware and physical sites |
| | housing the hardware that receives the ODMS updates. |

Hardware for Database Management System and Method

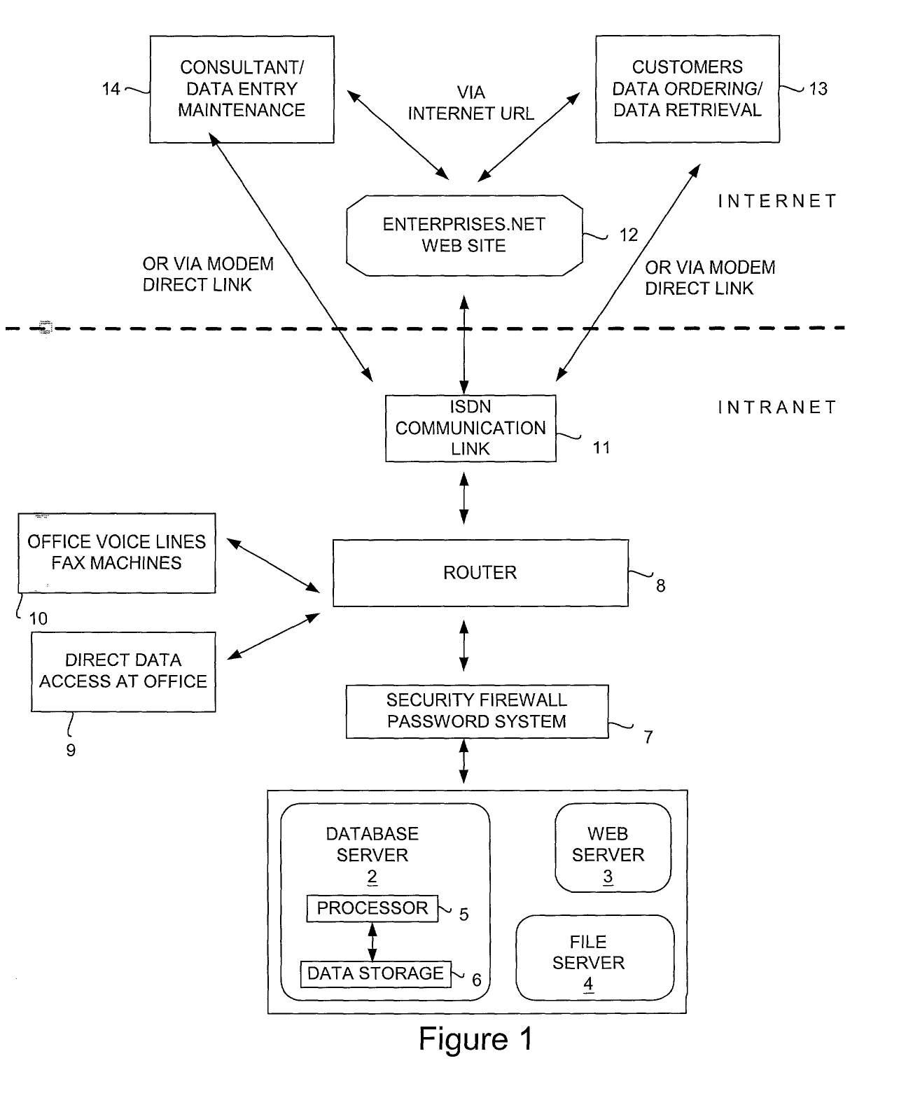

FIG. 1 is a functional block diagram showing an exemplary embodiment of a central database in order to collect and maintain data for the Database Management System and Method. As shown in FIG. 1, there is a server 1 which may be composed of a variety of servers including a database server 2, a web server 3 and a file server 4. Each of the servers may include a processor 5 and a data storage device 6. FIG. 1 shows, as examples, that the database server 2 includes a processor 5 and a data storage device 6. The data storage device 6 may include the data necessary for the Database Management System And Method. The server 1 may further include a security firewall password system 7 and a router 8. The router 8 routes data from a variety of sources, including for example direct data access 9 (e.g., data entry at a terminal), office voice lines for fax machines 10, or via an ISDN communication link 11. As shown in FIG. 1, an intranet may serve to connect the sources of data input (such as the fax machines, data entry devices, or other data lines to the server 1.

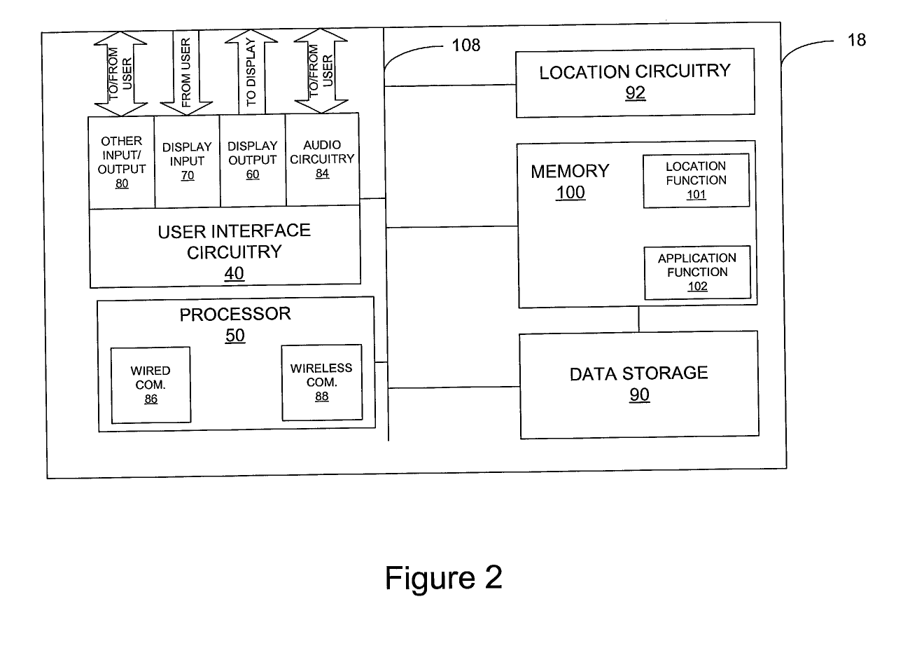

FIG. 1 further shows means for entering data via a location separate from the servers. The data may come from a variety of sources such as via a website 12, via a modem or other offsite link to customers, or via a modem or other offsite link to a consultant. For example, customers of the Database Management System And Method may order data/retrieve data, as shown at block 13, via a direct link to the communication link 11 or via an internet URL to a website 12. As discussed subsequently, the customer may monitor or access the data in the server 1 in this manner. In one aspect, the customer may use a Portable Information Device (PID) in order to communicate with server 1. An exemplary embodiment of a PID is shown in FIG. 2. In an alternate embodiment, the customer may use a standard personal computer to communicate with the server 1. As another example, consultants may enter data or maintain the database, as shown at block 14, via a direct link to the communication link 11 or via an internet URL to a website 12. In one aspect, the consultant may use a standard personal computer to communicate with the server 1. Alternatively, the consultant may use a PID to communicate with server 1.

FIG. 2 is a functional block diagram showing an exemplary embodiment of the Portable information device (PID) 18 that can communicate with other devices. PIDs are widely used. An example of a PID is a personal digital assistant (PDA), such as one of the Palm™ series of PDAs offered by Palm, Inc.

Memory 100 may contain a specific application function 102. The application function 102 may operate, for example, in conjunction with the operating system of the PID 18. One example of a specific application function is a scheduling function such as the waste route scheduler, as discussed subsequently. Another example of a specific application function is the wedding database function, as discussed subsequently. Memory 100 may also contain a location function 101. The location function 101 may operate, for example, in conjunction with the Location Circuitry 92 and Processor 50 in order to provide a location for the PID 18. One example of location circuitry is circuitry for locating based on the Global Positioning System (GPS).

A user interface circuitry 40 includes hardware and software components that provide user input and output resources for functions in the processor 50. The user interface circuitry 40 includes a display output 60, a display input 70, an additional input/output interface 80 and audio circuitry 84.

The display output 60 preferably receives digital information representing graphical data from the processor 50 and converts the information to a graphical display, such as text and or/images, for display on a display screen, for example.

The display input 70 may receive data inputs, such as graphical data inputs, from a user of the PID 18. The graphical data inputs are preferably entered by the user with a stylus on a pressure-sensitive display screen, and may include text, drawings, or other objects that are capable of being graphically presented.

The additional input/output interface 80 allows the user to enter other types of data besides graphical data into the PID 18. For example, audio data, additional graphical data, or additional input, such as video camera input for example, may be entered through the additional input/output interface 80. As discussed subsequently, if a picture is desired as an input, the PID can attach a picture to the data entry. The data may also include data formatted for operation with particular applications on the PID 18. For example, email data, calendar data, contact data, database data, spreadsheets, notes, game data, etc may also be entered. Touch-sensitive screen buttons are an exemplary method for a user to enter control data into the PID 18.

The audio circuitry 84 allows an audible signal to be generated in response to an application function 102 if the application function 102 requires audible notification of the user. As discussed subsequently with respect to the provided examples, the user may be notified at any point in the data management process by audible means.

The processor 50 may include an operating system, as well as application and communication software, to implement the functions of the PID 18. The operating system may be any suitable commercially available operating system, or any proprietary operating system. One example of an operating system is the Palm OS, as discussed below. The operating system and software may be stored in the data storage 90 in the memory 100, or may be embedded in the processor 50. Although the processor 50 is shown connected to the data storage 90 through a bus 108, other configurations may also be used. Similarly, the memory 100, and the application function 102, may be configured other than as shown in FIG. 2, and may be embedded within the processor 50.

Data may be entered, in addition to the User Interface Circuitry 40, through Wired Communication 86 and Wireless Communication 88. One example of Wired Communication 86 is by placing the PID 18 into a cradle or sync device and wherein the PID 18 “syncs” to an external device, such as another PID, a personal computer or a server, via the Wired Communication 86. Alternatively, data transfer from another PID, a personal computer or a server may be performed in a wireless manner using Wireless Communication 88.

Organizational Directory Management Services

With the exemplary hardware given in FIGS. 1 and 2, the Organization Directory Management Services may be implemented. The process flow may involve a four-step approach:

Establish Platform and Service Center

Client Interview

Data Collection

Data Distribution

Establish Platform and Service Center

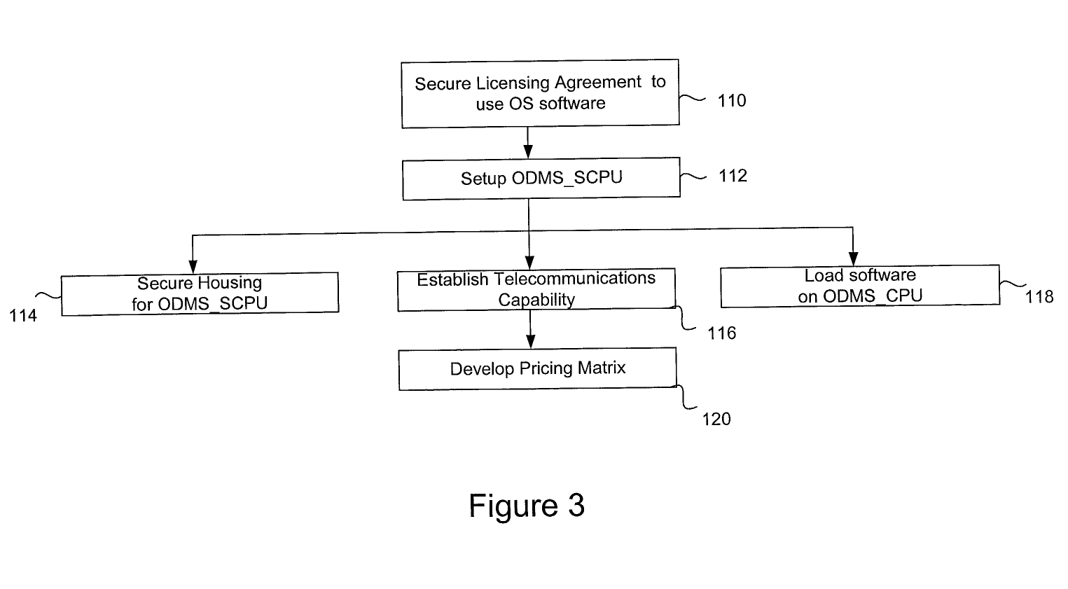

Referring to FIG. 3, there is shown a process flow diagram for establishing the ODMS platform and service center. The initial step is to establish a platform and a service center. This may involve the use of an operating system as the main platform for the data capture, which may be designed or may be licensed, as shown at block 110. The licensing may be accomplished through a licensing right negotiated with an OS authorized software provider, and a negotiated pricing agreement with a handheld device manufacturer to obtain the hardware to run the platform. Next, a centralized data storage facility is prepared to house the client data as its main collection point, as shown at block 112, wherein the ODMS_SCPU housing is secured (block 114), the telecommunications capability is established (block 116), and the software is loaded onto the ODMS_CPU (block 118). Referring to FIG. 1, the server 1 may serve as the centralized data storage facility and the telecommunications may include both wired (such as modem, ISDN communications links, or internet links) or wireless. This Secured Centralized Processor Unit (ODMS_SCPU) may become the main data storage hub for the data gathering and distribution for each client. The ODMS_SCPU may have separate secured file space capability established for each client's organizational directory. The ODMS_SPCU may have electronic output capability via disk storage, electronic transmission through telecommunication lines, and the Internet to accomplish the data transfer return to the client's computers.

The ODMS_SPCU may contain fields identical to the address book feature of the OS system. For example, in the Palm OS, each addressee has 19 maintainable data fields (with the number of fields in parentheses):

(1) Last name

(1) First name

(1) Title

(1) Company

(4) Phone numbers with variable titles, user can define title

(1) Email address

(1) Physical address

(1) City

(1) State

(1) Zip Code

(1) Country

(4) User defined custom fields

(1) User defined variable length notes field

The data fields can be manually data entered with new/updated information. Each addressee has a variable user defined sort option within the OS system which allows as many subcategories of addressees as the individual organizations wish to create. The ODMS_SPCU has the same subcategories, which can automatically subdivide the addressees for output to the ODMS_CDRC or ODMS_PS. The ODMS_SPCU provides secured electronic storage space for each organization that contracts the ODMS services. The initial address book can be created through manual data entry or an initial “async” from the ODMS_CDRC which may have been already started but not yet fully loaded with a completed addressee list. All subsequent data field electronic captures and sorts occur at the end of the data entry. This “updated” date/time stamped directory may then be replacement version to feed the ODMS_CDRC or ODMS_PS.

One aspect of the ODMS_SPCU is its ability to electronically capture all client data fields and out sort this data to a module that can be loaded into a proprietary system known as the ODMS Print Shop services (ODMS_PS). These services may consist of hard copy printed output of selected ODMS fields per client specified requests. In addition to the electronic hand held data storage, and/or at the client's discretion, in place of the electronic hand held data storage, the client may identify certain users in its organization that would work with hard copy printed outputs, such as:

Client telephone directories

Client address directories

Client Rolodex card files

Client binder tab dividers for cataloguing client in house reports

Client address labels

Client specified Mailings

Client organization charts

Since there are a designated number of fields (19 fields in the Palm OS) per addressee times “x” addresses (“x” defined by the size of the organization being services), these data fields can be bundled or segregated as the user desires, and the ODMS_PS produces hard copy formats that the ODMS management designs and offers for sale. The client may specify the quantity of each deliverable service, and pricing may be affected according the order size.

Finally, a client pricing matrix is developed, as shown at block 120, to capture direct costs associated with each service offered, and the add on margin necessary to cover variable overhead and profit. This matrix may be transformed into a client ready price quote schedule.

Client Interview

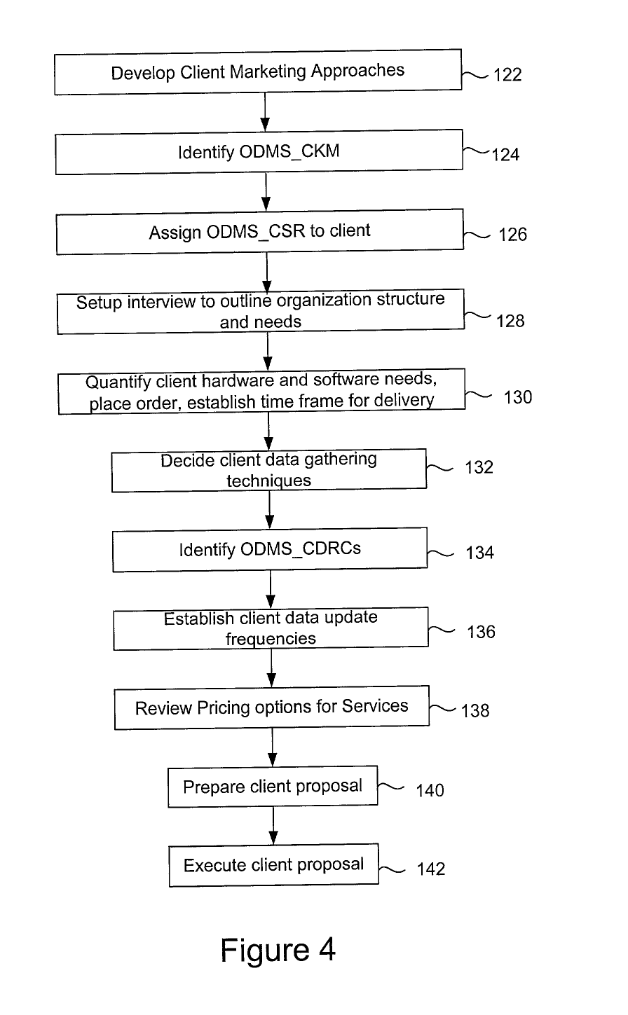

Referring to FIG. 4, there is shown a process flow diagram for the ODMS client interview. As shown at block 122, client marketing approaches are developed. Marketing the ODMS product is accomplished through various direct solicitation with clients, including direct contact through telemarketing, advertising through standard practices such as mail solicitation and Internet ads, and cold calls to the prospective client offices. Once the client indicates interest in procuring the services, a key element to closing the sale may include the following steps:

Identify client key manager (ODMS_CKM), as shown at block 124, to study organizational structure and assign ODMS Customer Service Representative to client, as shown at block 126

Setup interview with ODMS_CKM, as shown at block 128, to outline the organizational structure

Quantify client hardware and software needed to use ODMS, as shown at block 130

Agree to a data gathering approach, as shown at block 132

Identify client computers that will receive ODMS output, as shown at block 134

Establish time frame for data update needs, i.e weekly, monthly quarterly, etc., as shown at block 136

Review pricing options for services, as shown at block 138

Prepare client proposal, as shown at block 140 and execute client proposal, as shown at block 142

Upon completion of the interview, a formal proposal may be prepared by the ODMS customer service representative (ODMS_CSR) outlining what services will be initially purchased, how the data will be gathered, how the data will be distributed, when the data will be distributed, and total cost for the services. Optional additional ODMS print shop services (ODMS_PS) can be communicated at this time with the client getting a full understanding of the scope of the business productivity options offered through these services.

Data Collection

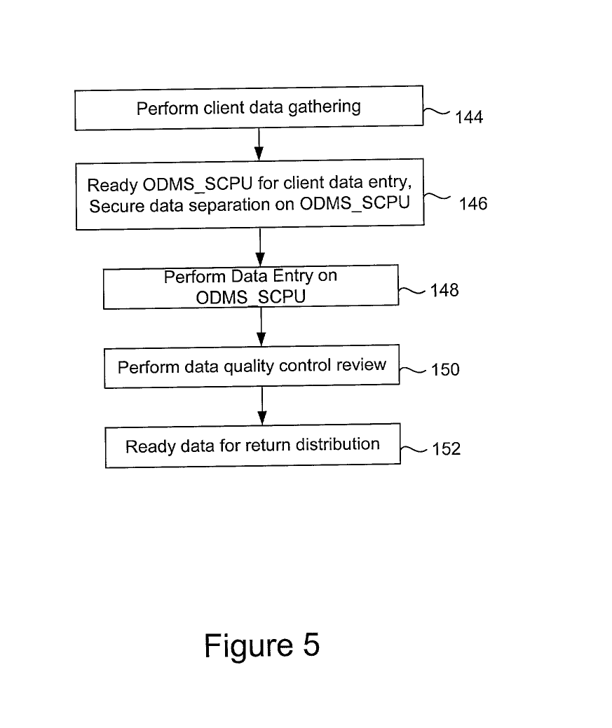

Referring to FIG. 5, there is shown a process flow diagram for the ODMS data collection. Once a proposal has been agreed to, there are a variety of data collection methods available to initiate the process. These include:

1) Client hard copy reports can be gathered by ODMS_CSR at client office and copied.

2) Electronic purge of the client computer system can be performed by ODMS_CSR and transferred to portable computer disk media or portable computer in a manner ready for input by the ODMS_SPCU.

3) Optionally, the client can perform same gathering of data using techniques 1 and 2, and mail or electronically send same data to the ODMS offices via ground shipping, facsimile, or Internet E-mail output.

Once the data is collected from the client, as shown at block 144, the information is readied for input into the ODMS_SCPU (secured computer processing unit), as shown at block 146. A secured client ID separates the data on the ODMS_SCPU (block 146), and the data entry is then performed for all client information for the directory to be maintained, as shown at block 148. Once the data is completely entered, a quality control review is performed, as shown at block 150. In one embodiment, quality control is an ODMS management defined procedure whereby each data field is compared to a standard to insure consistency is the data entry.

For example, ODMS may choose to enter phone numbers in this format:

xxx xxx xxxx versus
(xxx) xxx xxxx versus
xxx-xxx-xxxx

The standards quality control review results in continuity of data entry for all ODMS customers. This value added service insures that future enhancements in technology, such as new software programs that can automatically feed the data from the OS system, will have consistent data fields to start with. Quality control reviews insure that these data fields are in readily known formats, when these data fields are captured in other software designs.

Upon satisfactory review, the data fields are prepared for return distribution to client, as shown at block 152. In one embodiment, the data fields are “prepared” for return distribution to client by refreshing the date/time stamp so that the data is ready for its next “async” in the ODMS_CDRC.

Data Distribution

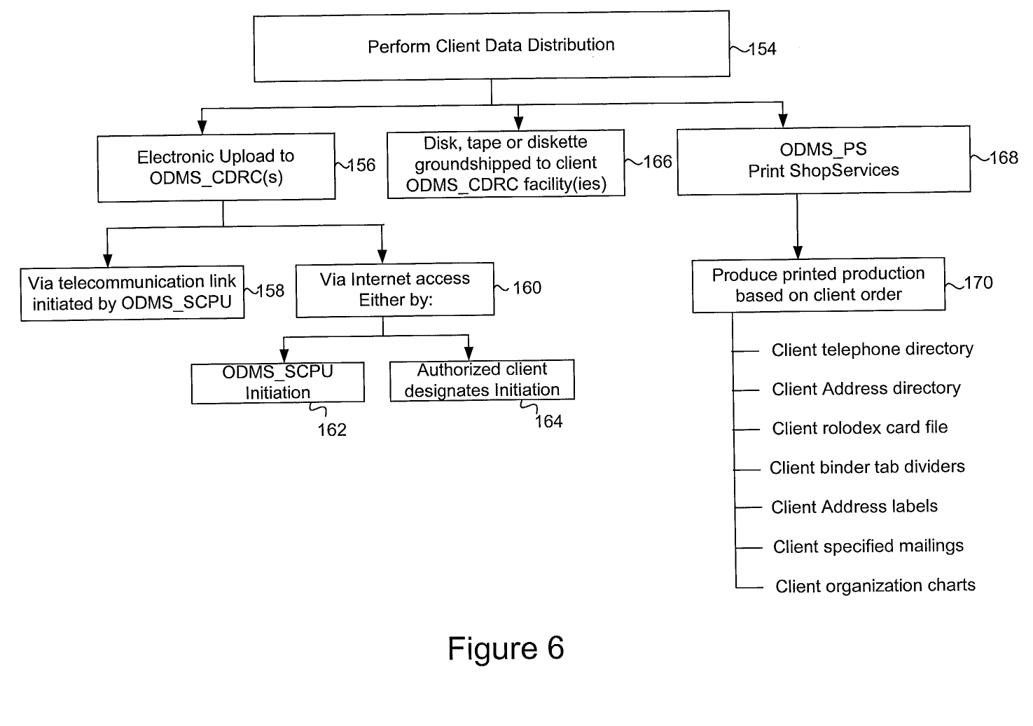

Referring to FIG. 6, there is shown a process flow diagram for the ODMS data distribution. Once the data entry is completed, the return of the updated database is performed in any one of three methods (or a combination of those methods).

1) Electronically (as shown at block 156), through a telecommunication link direct to the client designated receiver computers (as shown at block 158), or through the Internet email system (as shown at block 160), which can be initiated by either the ODMS_CSR (as shown at block 162), or if the client desires, their authorized designate can initiate the upload from their offices to the ODMS_CDRCs (as shown at block 164). For example, using a direct telecommunication link, the ODMS_SPCU initiates a direct telecommunication link with the ODMS_CDRC to transfer the most recent file. Alternatively, the ODMS_CDRC could likewise initiate the link with the ODMS_SPCU for the same procedure. As another example via the internet, the same data transfer could be accomplished through standard links with the ODMS and organizations web sites. The ODMS_CKM has the responsibility to notify the organization hand held users that the directory has been updated and the hand held users need to perform an “async” with the ODMS_CDRC at their earliest convenience. Alternatively, ODMS management can initiate emails to each hand held user in the respective organizations as notification. This may be another fee based option for the ODMS customer to decide upon.

The information is then updated (preferably in an asynchronous manner) on the ODMS_CDRCs. Once notified, the client handheld users then make arrangements to cradle their handhelds at the ODMS_CDRC at a time convenient to the user. Because the ODMS address directory product is generated as a separate subsection of the address book, asyncs do not overwrite any personal data that the individual hand held users are maintaining.

2) The updated database may also be downloaded to disk or diskette medium and ground shipped returned to the ODMS_CDRC facilities, as shown at block 166. The information is then updated (preferably in an asynchronous manner) and the ODMS_CDRCs then are ready for handheld device updates for designated client hardware users. Handheld users are then notified of the availability of the new database and make arrangements to cradle their handhelds at the ODMS_CDRC at a time convenient to the user. Because the ODMS address directory product is generated as a separate subsection of the address book, asyncs do not overwrite any personal data that the individual hand held users are maintaining.

3) The updated database may further be fed into the ODMS_PS, where individually ordered hard copy products are printed, as shown at blocks 168, 170. These products could be Client telephone directories, Client address directories, Client Rolodex card files, Client binder tab dividers for cataloguing client in house reports, Client address labels, Client specified Mailings which may be correspondence that the client would provide a template for and would then be personalized via a selection of ODMS selected addressees, or Client organization charts. Once the hard copy output is generated, it is sorted and ground shipped direct to the client designated facilities.

The versatility of the method of the return of the data becomes a key value added service provided to ODMS client users.

The Database Management System and Method may be applied to a variety of contexts. One such application is for organization and analysis of stops in a scheduled route. Scheduled route examples include, without limitation, delivery (such as mail delivery) and/or pickup (such as garbage pickup). As an example of the system and method of one aspect of the current invention, applicant provides analysis of a waste route.

Waste Route Analysis

As discussed, the present invention may be applied to many contexts of electronically organizing and managing service routing, and analyzing profitability of solid, special, or medical waste disposal customers. It involves utilizing database management. In a preferred embodiment the “Palm OS Address Book” application is used in conjunction with application function 102, as a program executable to store waste industry service address locations and other data, by route, so as to have a mobile, easily updated “electronic route book” capability.

This “electronic route book” may contain sequenced customer stop data, which because of its electronic design characteristics, can allow route stop data and/or cost/productivity analysis to be gathered in a new proprietary way that will enhance the client's ability to effect operational and marketing changes, resulting in increased profitability of each of the routes being managed in this way. Alternatively, a separate program may be installed on the PID executable to store waste industry service address locations and other data, by route.

The application function 102 may be a program resident on the PID which uses specific functions resident on the PID, such as the Address Book, in order to efficiently enter data. In the Palm OS, the Address Book has 18 maintainable fields plus the Note capability. As shown below, there are several fields in the Palm OS including “Last Name” or “Company Fields.” The Palm OS allows for sorting by either the “Last Name” or “Company” Fields. Utilizing these fields to store Service Address and Route Sequence Number can give a service list in a prescribed order. In the waste industry example, this allows for the definition of a refuse service route—the stops in the precise order in which they are visited. Moreover, other features of the Address Book may be used to tailor the particular application. In the waste industry example, the “Category” feature of the Address Book may be used to segregate the Service Addresses by Route Day (i.e., Sunday through Saturday). This is an efficient method of segregating the Service Addresses so that each stop for each day of service can be tracked and sorted by “route day.” The importance of this productivity-enhancing feature will be further explained as the complete methodology is detailed.

Table 1 shows one embodiment of the waste industry example wherein sections of the address field are used for the specific application.

TABLE 1
Exemplary Data Map for Waste Route Example:

| Palm OS Address Field | Data Management System Field |
|---|---|
| Last Name | Service Address |
| First Name | Customer Name |
| Title | Yards Picked Up |
| Company | Sequence Number |
| Street | Specific Service Advice |
| City | |
| State | |
| ZIP | |
| Country | |
| Phone Number 1 | Customer Service Contact |
| | Phone Number |
| Phone Number 2 | |
| Phone Number 3 | |
| Phone Number 4 | |
| Phone Number 5 | |
| Custom 1 | Time IN |
| Custom 2 | Time OUT |
| Custom 3 | Containers |
| Custom 4 | Exception Y or N |
| Note | Detail of Exception |

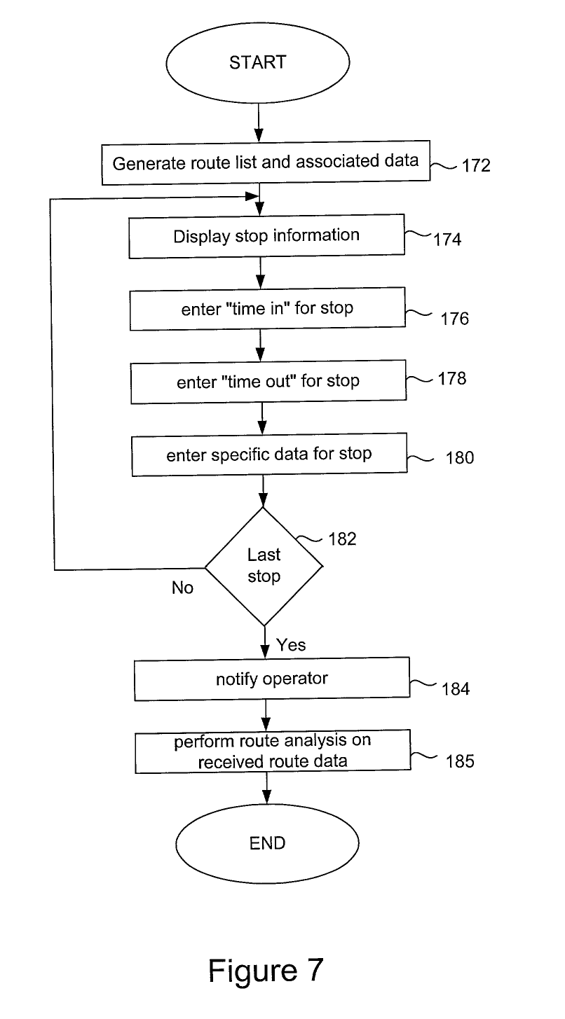

Referring to FIG. 7, there is shown a flow chart of one embodiment of the waste industry example using the Address Fields of the PID. As shown at block 172, the route list and associated data is generated. In one embodiment, the route list is supplied to one of the Address Fields. In a preferred embodiment, this information is entered into the “First Name” and “Last Name” fields in the Palm OS. Moreover, the route list may be entered either by hand or electronically from an existing client routing system. In the context of the definitions provided above, Client ODMS client key manager supplies route lists to ODMS customer service representative, either through paper or electronic feed from existing client routing system. ODMS customer service representative, through pure data entry or electronic feed via the Palm OS “file link’ feature, readies the Address Book data, by day, by service address, in the order in which the route is picked up.

The Address Fields are transferred to the PID. This may be accomplished by data entry or via an electronic feed. In the example of the Palm OS, “file link’ feature, readies the Address Book data, by day, by service address, in the order in which the route is picked up. Then this enhanced .ABA file is returned to the ODMS_CDRC of choice via the following mediums: As a file attachment through an email or data file link to a website, or though disk, diskette, tape or other hard copy data file.

In one embodiment, the data in the Address Fields may be manipulated. In the example of the Palm OS, the main program receives the enhanced .ABA file, the ODMS client key manager arranges a synch with the desktop version of the Palm OS address book, with each route being added as a separate user, to segregate the data, which will allow a more efficient file update in the future as changes are made to the client routing system. Then, the ODMS client key manager synchs the desktop address book(s) with the client PID that will house the route data. This PID can be assigned to a specific route where the number of PIDs can equal the number of route trucks, or in the event there is a prescribed use (such as Waste Route analysis described below) the PID can be loaded with specific route data for the specific purpose. In this manner, the user can choose how many PIDs to employ utilizing the Waste Route methodology. The user may therefore control how much of an investment to make in PIDs without prohibiting the ability to use the Waste Route system.

The route list may include the stops in the route for a predetermined time period (e.g., all the stops for one day). Associated data may include the data associated with a particular stop. This information may include, for example, the amount of waste estimated to be picked up at a particular stop, maps/directions from a previous stop to the particular stop, special instructions for the particular stop (e.g., take a picture of the waste containers at the particular stop), etc. The associated data may be transferred to the PID in a variety of ways. For example, Wired Communication 86 or Wireless Communication 88 of the PID 18 may transfer the data for the route list from a server 1, personal computer, or other PID.

The PID may then be given to the route driver at the start of the day. The driver is given basic instructions on the operation of the PID in combination with the waste route associated data. For example, the driver may be shown how to open the route service address directory. In this way, the PID becomes an electronic route summary, which replaces hard copy printouts or route books. The benefits result in reduced costs of paper/binder systems and in quick recovery of data capability, in the event of a lost Waste Route PID. For example, if a PID is lost, a new PID may be downloaded with the route information (e.g., the .ABA file residing on the ODMS_CDRC can easily be synched to a new PID and its memory 100 may be updated in the event of a loss of the device).

The client directs how the route driver will interact with the Waste Route service address directory. In one aspect of the invention, the driver may log information about the waste route. One such piece of information regarding the waste route associated date may be the amount of waste removed. In addition, other service issues may be logged as the route is being serviced, i.e. blocked access, overfilling container, or other service issues, all of which could be created in the Note file, by customer. Additionally, the route driver may have the contact phone number handily available to call if an unexpected service issue arose. Any service issues noted may be flagged for review by client management, simply by looking for any notes created in the Waste Route service address directory by the driver during the route day, once the PID is returned to the office at the end of the route day. This new information could then be returned as an update to the client's routing/operations/sales system via another file export of the pertinent fields.

Moreover, in another aspect of the waste route invention, specific driver instructions on data gathering enable the system to perform route productivity/cost analysis.

After the route information is prepared, the route driver is given specific instructions on the data that the driver will be capturing for an entire route day and/or week. An incentive of implementing the system is that route productivity/cost analysis can be performed simply by the driver while in the normal course of the driver's duties. The standard practice in the past has been to have an additional employee, known as a route checker, accompany the route driver and perform the data gathering separately. Because of the efficient and simple data capture employed in the system of the current invention, the entire expense of a route checker can be saved. Additionally, once the route audit data is captured, the resulting enhanced data can be forwarded for analysis of route costing, alleviating the client's need to dedicate resources internally to do the costing. In the present example, the .ABA data file can be forwarded to an ODMS_CSR to perform the route costing, as discussed subsequently with respect to block 185. Hurdles of costly overhead associated with the prior art method of doing route analysis are therefore removed, the result of which is a more timely and accurate turnaround of this data to client management for corrective operating and sales actions, all of which, improve the route profitability.

In a preferred embodiment, the route driver follows the route list, traveling from stop to stop. At the beginning of the route, the information about the first stop is displayed, as shown at block 174. In one embodiment, the application function 102 automatically accesses the route list resident in data storage 90 and displays the information regarding the first stop. This information may include address information. Additionally, the information may include a map/directions to the stop.

Upon arrival at a stop in the route list, the route driver enters the “time in” for the stop, as shown at block 176. The entry of “time in” or arrival time for a stop may be done in several ways. In the preferred embodiment, the entry may be performed by simply tapping, with a stylus, the field designated on the display as “time in.” The software registers the tapping of the stylus on the “time in” field, reads the time on the internal clock on the PID, displays the time on the internal clock and records the “time in” in data storage 90. The display of the time may be in the field designated as “time in.” Alternatively, the display of the time may be in a separate field. In an alternate embodiment, the entry of “time in” may be performed by the route driver determining what the time is, and entering the time using the stylus. For example, if the route driver determines that the time is 10:00 am, the route driver will enter the number “1000” to represent 10:00 am. In still an alternate embodiment, the entry of the “time in” may be performed automatically. For example, the information regarding the stop may be compared with the actual position of the vehicle through, for example, having the position of the vehicle be determined by the Global Positioning System (GPS) using Location Circuitry 92 and comparing that position (using processor 50) to the latitude and longitude of the stop. When the vehicle is within a certain distance of the stop, the time may be automatically registered as the “time in.”

After the route driver loads the waste into the vehicle, the route driver enters the “time out,” as shown at block 178. The entry of the “time out” may be similar to the entry for the “time in.” In an alternate embodiment, the entry of the “time out” may be performed automatically. For example, similar to the automatic entry of the “time in,” the entry of the “time out” may be determined when the position of the vehicle moves away from the stop (whose position is programmed). As another example, the automatic entry of the “time out” may be determined when the route driver enters the specific data for the stop, as discussed subsequently. Specifically, when the PID will read the clock time and automatically register the time as the “time out.”

The route driver may then enter the quantity of waste picked up from the particular stop, as shown at block 180. In a preferred embodiment, and for ease of use, the amount of waste expected from the stop is displayed. If the amount of waste picked up is the same as what was expected, no additional input is necessary (i.e., the expected amount becomes the actual amount). If the amount of waste picked up is different from what was expected, the route driver taps, with the stylus, the field on the display entitled “exception.” The route driver is then provided with a pop-up menu of amounts of waste which are in the range of the expected waste. For example, if the expected waste was 3 cubic yards, and the “exception” is tapped on the display, a pop up menu including a list of 0.0, 1.0, 1.5, 2.0, 3.0, 4.0, etc. The route driver may then simply tap the correct amount of waste that was picked up. Alternatively, the route driver may enter the data directly. For example, if the amount of waste is 3 cubic yards, the route driver may enter the number “3.0 ” in the “yards picked up” field.

Other examples of data specific to the stop could include entry of a photograph, for example. If a picture is desired of the waste site, the PID can attach a picture to the data entry. Commercially available digital cameras may be attached to the PID. One commercially available digital camera is Kodak® PaimPix®.

The sequence for the entry of data may be done in a variety of ways. In a preferred embodiment, the sequence for entry of the data is “time in” entry, “time out” entry and entry of the data specific to the particular stop (e.g., amount of waste). Alternatively, the sequence of data may be different. For example, the entry of data may be “time in,” data specific to the particular stop, and “time out.”

After the data is entered for a particular stop, it is determined whether the stop is the last stop in the route, as shown at block 182. If it is not the last stop, the program loops back, beginning the sequence again. In a preferred embodiment, the information for the next stop is then displayed. This sequence continues until the data for the last stop is entered. Thereupon, the route driver is notified that the route is finished, as shown at block 184, and the program exits.

After the route is finished, the “data gathered” information which is compiled in the PID by Customer such as “time in,” “time out,” Noted Exceptions to Yardage Containers or Sequence, photos, etc, is turned into the office at day or week's end.

Once an entire route week has been “data gathered,” the data is transferred to a central storage facility. The data may be transferred either in a wired or a wireless manner to another PID, a computer or a server. In the specific example, the updated .ABA is sent by the ODMS customer key manager to the ODMS customer service representative either through electronic or hard copy means.

The data gathered (in the form of an .ABA file) may then be sent to a program for analysis, as shown at block 185. The transfer of data is, in a preferred embodiment performed automatically. For example, the “Send To’ command in the Palm OS, may automatically transfer the data. Alternatively, the data may be transmitted manually.

In one embodiment, the data is loaded into an electronic spreadsheet, and the route is costed out as follows:

a. All time at stops is summed and becomes a variable basis for allocating direct labor and trucking costs to each customer. Based on the entire routes time study a cost per minute is calculated and the specific minutes spent at the customer is extended by the cost per minute.

b. All time between stops is calculated and allocated to each customer as a function of being part of a route setup. The total cost of the between stops time is allocated back to the customer based on the number of stops counted on the route check, i.e., a Monday, Wednesday, Friday customer may be allocated 3 times the cost/stop for the week.

c. Travel time devoted to trips to dispose of the waste is summed and becomes a variable for allocating disposal expense to each customer. Based on the entire route's time study, a total cost for landfill travel time is calculated. This cost in addition to the actual tipping fee is added together and becomes the basis for allocating yardage costs. This combined landfill cost is allocated back to the customer based on the yardage picked up for each of the service stops performed during the timeframe of the route check at the specific customer's location.

Once the three costs are allocated to each customer on the route, typically, one week's worth of information becomes the basis of evaluating individual customer profitability, and is compared to a comparable allocation of revenue being generated from the customer. If a customer is charged a flat monthly fee, that revenue fee is divided by 4.33, and compared to the route check cost results. If the customer is charged on a rate per yard basis, the total yards serviced is extended by the revenue per yard and then compared to the total costs. In either scenario, the ranking of all customers serviced during the route check can be presented from a worst case to best case presentation, to highlight necessary operations or sales issues that can then be addressed by the client's management team.

Once costed out, the electronic spreadsheet is saved and readied for return to the client, again either through electronic or hard copy means.

The Database Management System and Method may also be applied to the context of event planning. As an example of the system and method of this aspect of the current invention, applicant provides analysis of a wedding database.

Wedding Database

The present invention may be applied to the context of digitally organizing and assisting the planning of a wedding. Utilizing the same PID database management techniques (for example, the “Palm OS address book”), and data obtained from the ODMS client key manager, (in this example, the ODMS client key manager could be the groom, bride, or their designated wedding planner) the ODMS customer service representative can assemble and generate guest lists to be used to more effectively manage the invited guest selection process. The Master Invited Guest List, assembled from the bride and groom families, the Invited Guest List (a byproduct of guest cut down decisions performed on the Master Invited Guest List), and the Final Invited Guest List (the result of invitation replies), have contact information which can easily be organized, and segregated through separate categories established in the “Palm OS address book” standard configuration, either on a desktop or PID. Selected fields from these lists then can be sent to the ODMS print shop services module, or viewed and adjusted directly on the desktop and/or PID to facilitate the following:

a) Managing guest characteristics details to assist in determining the Invited Guests, and a potential order of cut down,

b) Guest Invitation addressing and special instructions, and/or general or individualized directions to the services/reception locations,

c) Generating digital or printed guest lists to assist the various functions of the wedding service providers; including photographers/videographers, florists, food and drink providers, entertainment providers, gift control and/or summary detailing of gifts received, or complimentary guest electronic and/or hard copies of the bride and groom's newly combined “friends and family address book”, etc.

d) Table place cards at the reception

e) Thank you gifts to the wedding party members and/or other guests

f) Addressing thank you notes and individualizing the thank you when “summary detailing of gifts received” has been performed

In today's marketplace, wedding planning is increasingly becoming more time consuming as elaborate traditions and new customs adopted based on family preference is incorporated into the process. The treatment and handling of guests invited to the various ceremonies and receptions can be significantly streamlined, thereby saving time, through the use of ODMS Wedding Management Services.

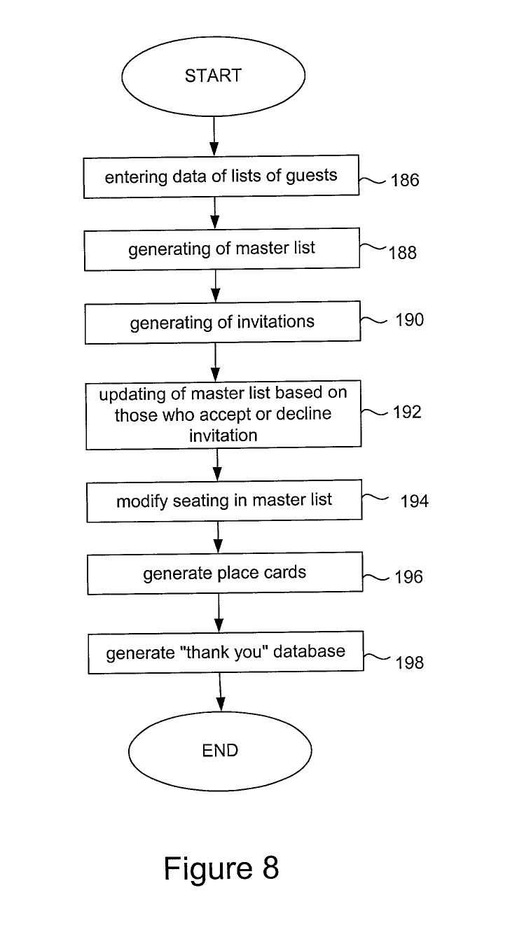

Referring to FIG. 8, there is shown a flow chart of the wedding planning database management system. As shown at block 186, the data is entered of the lists of guests. Typically, the bride, groom, bride's parents and groom's parents each have lists of potential Invited Guests of their own. These lists may be entered by each of those people for a total of four lists, for example. The data entered in the list may include, but is not limited to: full name of invitee(s); address of invitee(s); whether invitee will bring a guest; whether the invitee will be definitely invited to the wedding or whether the invitee is a “maybe”; whether the invitee is a guest of the groomsman or bridesmaid; whether the invitee(s) are invited to the rehearsal dinner; where the invitee(s) should be seated at the reception; etc. This data is entered in the designated mapped fields of the Palm OS address book on a desktop and/or PID:

TABLE 2
Exemplary Data Map:

| Palm OS Address Field | ODMS_WDMS Field |
|---|---|
| Last Name | Last Name |
| First Name | Guests Name(s) |
| Title | Mr., Ms., Mr. & Mrs. |
| Company | Relationship in Family |
| Street | Street |
| City | City |
| State | State |
| Zip Code | Zip Code |
| Country | Country |
| Phone Number 1 | Guest Home Phone Number |
| Phone Number 2 | Guest Email Address |
| Phone Number 3 | |
| Phone Number 4 | |
| Phone Number 5 | |
| Custom 1 | Wedding Service “Guest |
| | Likelihood” Indicator |
| Custom 2 | Wedding Service “Guest |
| | Services” Indicator |
| Custom 3 | Wedding Service “Place |
| | Card” Indicator |
| Custom 4 | Wedding Service “Gift |
| | Summary” Field |
| Note | Wedding Service Freeform |
| | Capture |

After the lists are entered, the Master Invited Guest list is generated, as shown at block 188. Then, this list may be copied into a separate Palm OS address book category as the beginning point for the Invited Guest List. In one embodiment, the Master Invited Guest list is a composite of the lists of the bride, groom, bride's extended family and groom's extended family. Typically, the Master Invited Guest list for a wedding is then reduced based on the wishes of the bride and groom. In order to reduce the size of the list, those potential invitee(s) who are listed in the “maybe” category may be printed, examined and potentially removed from the Master Invited Guest List. For example, the ODMS customer service representative may forward, electronically or in hard copy, the Master Invited Guest List, to the bride and groom. The Master Invited Guest List may then be reduced to the Invited Guest List. Specifically, the ODMS customer service representative may adjust the .ABA file to update the Invited Guests List.

Once the Invited Guest List is compiled, it is copied into a separate Palm OS address book category as the beginning point for the Final Invited Guest List. As shown at block 190, the invitations are generated. This may be performed by creating an address file. Moreover, the invitations can be personalized thru the ODMS print shop services products. All aspects of the invitations may be printed including: (1) the printing of the name and address of the invitee(s) on the main envelope; (2) the printing of the names of the invitee(s) on the interior envelope; (3) the printing of a map/directions to the rehearsal dinner location, ceremony hall, and/or reception hall (this optionally may be personalized by using a mapping program based on the address of the invitee(s) as the starting point and the address of the rehearsal dinner location, ceremony hall, and/or reception hall as the ending point).

Once compiled, the invitations are mailed, and the potential invitee(s) send in their responses, either accepting or declining the invitations. Based on the responses, the Invited Guest list is updated based on those who accepted or declined the invitation, as shown at block 192. After updating, the adjusted Invited Guest list is generated and saved. The end result is the Final Invited Guests List. The seating of the guests is determined and the master list is updated to determine where the invitee(s) will be seated at the reception, as shown at block 194. Then, an ODMS print shop services “place card” product can be ordered. Specifically, the name of the guest and the table where the guest will sit are printed on the place cards, as shown at block 196. These are then staged at the reception to guide the guests.

Based on preference, the bride and groom can also opt to distribute electronic and/or hard copies of the bride and groom's newly combined “friends and family address book”. The selection of this product is flexible in that this list can be either the Master, Invited, or Final guest list, or any variation thereof.

Once the wedding day has been completed, a summary of gifts received by the bride and groom, by Invitee, can be entered into the appropriate ODMS Wedding Database Services field. This will assist in personalizing the thank you notes. Additionally, the ODMS print shop services addressing of the thank you note envelopes can be performed, as shown at block 198. Additionally, other post wedding notes can be attached to the invitee list, such as a cross-reference from other wedding service providers, e.g., the photographer's list.

From the foregoing detailed description, it will be appreciated that numerous changes and modifications can be made to the aspects of the invention without departure from the true spirit and scope of the invention. This true spirit and scope of the invention is defined by the appended claims, to be interpreted in light of the foregoing specification.

What is claimed is:

1. A method for electronically recording data for a waste route, the method comprising the steps of
providing a device with data associated with destinations on the waste route; and
repeating, for each of the destinations on the waste route, the steps of:
traveling to a destination on the waste route;
electronically recording an arrival time for the destination on the waste route;
electronically recording an amount of waste collected for the destination on the waste route; and
electronically recording a departure time for the destination on the waste route.

2. The method as claimed in claim 1, wherein the device is a personal information device.

3. The method as claimed in claim 1, wherein the data associated with destinations includes addresses for the destinations.

4. The method as claimed in claim 1, wherein the step of electronically recording an arrival time is performed by an operator.

5. The method as claimed in claim 1, wherein the step of electronically recording an arrival time is performed automatically.

6. The method as claimed in claim 1, wherein the step of electronically recording an amount of waste includes the steps of:
providing an operator with an expected amount of waste for the destination;
receiving an input by the operator indicating whether the amount of waste equals the expected amount of waste for the destination; and
recording an amount based on the input from the operator indicating whether the amount of waste equals the expected amount of waste for the destination.

7. The method as claimed in claim 1, wherein the step of electronically recording a departure time is performed by an operator.

8. The method as claimed in claim 1, wherein the step of electronically recording a departure time is performed automatically.

9. The method as claimed in claim 1, further comprising the step of electronically recording pictorial information for the destination.

10. The method as claimed in claim 1, further comprising the steps of:
generating the data associated with destinations on the waste route; and
transferring the data to the device.

11. The method as claimed in claim 1, further comprising the steps of:
transferring the electronically recorded data regarding the arrival times, the amount of waste and the departure times for each of the destinations; and
analyzing the electronically recorded data regarding the arrival times, the amount of waste and the departure times for each of the destinations.

12. The method as claimed in claim 11, wherein the step of analyzing includes analyzing costs of collecting waste for each destination.

13. In a system for electronically recording data for a waste route, the improvement comprising:
a program executable by a personal information device (PID), said program comprising a set of instructions for electronically recording data for destinations on the waste route according to the following steps:
electronically recording an arrival time for each of the destinations on the waste route;
electronically recording an amount of waste collected for each of the destinations on the waste route; and
electronically recording a departure time for each of the destinations on the waste route.

14. A method for organizing data for a wedding, the method comprising the steps of:
electronically compiling a master list of guests for the wedding;
generating invitations for the wedding based upon the master list of guests;
modifying the master list of guests based upon responses to the invitations;
electronically generating placecards based upon the modified master list of guests; and
electronically generating a database regarding the modified master list of guests.

15. The method as claimed in claim 14, wherein the step of electronically compiling a list of guests for the wedding comprises:
entering, using a computer, data for lists of guests; and
generating the master list of guests by combining the lists of guests.

16. The method as claimed in claim 15, wherein the step of entering, using a computer, data for lists of guests includes entering a list of guests for a bride, entering a list of guests for a groom, entering a list of guests for parents of the bride and entering a list of guests for parents of the groom.

17. The method as claimed in claim 14, wherein the step of electronically generating a database regarding the modified master list of guests includes generating a thank-you database which includes at least one entry for each listing on the modified master list.
